(19) United States
(12) Patent Application Publication
(10) Pub. No.: US 2003/0072834 A1
(43) Pub. Date: Apr. 17, 2003

(54) Single mold structure for fabricating multiple USB ethernet network adapter

(76) Inventors: Chun-Chieh Wang, Chang Hua Hsien (TW); Mei-Fang Wang, Hsin Cnu Hsien (TW)

Correspondence Address: POWELL, GOLDSTEIN, FRAZER & MURPHY LLP, P.O. BOX 97223, WASHINGTON, DC, 20090-7223, US

(21) Appl. No.: 09/989,114

(22) Filed: Nov. 21, 2001

(30) Foreign Application Priority Data
Oct. 12, 2001 (TW) 90217463

(51) Int. Cl. B29C 45/00

(52) U.S. Cl. 425/190

(57) ABSTRACT

The present invention discloses a single mold structure for fabricating multiple external network adapters. The casing of the network adapter is produced by a single mold structure having multiple surface design of an interchangeable mold core. The interchangeable mold core can be replaced by another interchangeable mold core having different surface pattern during a manufacture interval. It can save a lot of time to change the mold core while producing and shorten a lot of time for creating molds during research and development stage. Finally, it can make the product come in more efficiently and can satisfy the customer requirement.

### FIELD OF THE INVENTION

The present invention relates to a mold for a mini Universal Serial Bus (USB) Ethernet network adapter, and especially to a mold with an interchangeable mold core. The interchangeable mold core can be replaced with another one on the injection-molding machine directly and immediately according to the production requirement.

### BACKGROUND OF THE INVENTION

With the wide spread of personal computer and rapid development of network, how to simplify the procedure of connecting personal computer to networks turns to be a huge need in the field of computer engineering. In generally, a network socket includes a standard RJ-45 connector having 8-wire cable. When connecting a personal computer to the network, the computer needs to add an external adapter or internal network card to provide network ports. However, some personal computers without the network card cannot directly employ the network socket to connect with the network.

It can be improved via an USB Ethernet external network adapter. The USB is widely used in the personal computer as an input/output port and the Ethernet is widely used in the network service. The combination of the USB and Ethernet can serve more users to connect the network and use the resource thereof. Thus, the need of USB and Ethernet network adapter grows up. To satisfy request of the most customers, it should make more molds to produce differently looking casing of the external network adapter. But it causes the mold cost increased, the manufacture cost increased, the research and development time increased and the product launch schedule put off. Finally, it cannot fit in with the rapid marketing changes.

For resolving the above disadvantages, the present invention discloses the multiple mold core design of single mold structure for external network adapter.

### SUMMARY OF THE INVENTION

One object of the present invention is to provide an injection mold with an interchangeable mold core. The injection mold can produce different pattern casings by changing the mold core but not the whole mold set. Especially, it may change the mold core in the injection-molding machine directly. That is, it is not necessary to remove the whole mold set from the injection-molding machine while producing a plurality of products.

When producing the different pattern casings, it only replaces the interchangeable mold core in the injection-molding machine. It can save a lot of time to change the mold while producing and shorten a lot of time to create molds while research and development stage. Finally, it can make the product come in more efficiently and satisfy the customer requirement.

For achieving the above and other objects, the present invention discloses a single mold structure for fabricating multiple USB Ethernet external network adapters. The mold includes a female mold core for forming the appearance of an injection-molding product; a mold cavity coupled with the female mold core; an male mold core for forming the interior structure of the injection-molding product; a mold plunger coupled with the male mold core; and a linking mechanism for coupling the mold cavity and the mold plunger together. The interchangeable mold core has a plurality of patterns to produce a plurality of textures of injection casing of the USB Ethernet external network adapter. Because that the interior of the mold core has no cooling pipe requirement, the dimensions of the mold core may be more compact.

In another aspect, the present invention provides a multiple injection casing produced by an injection mold with an interchangeable mold core and used in an USB Ethernet external network adapter. The multiple injection casing comprises an interchangeable upper cover having the same interior mechanism structure and an interchangeable lower cover having another same interior mechanism structure. The surface textures and colors of the upper cover or the lower cover are changeable, and thus various combinations thereof may be produced to provide more appearance choices.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic perspective view of an injection mold in accordance with one preferred embodiment of the present invention;

FIG. 2 is a schematic perspective view of a product, wherein the casing produced by the injection mold of FIG. 1 in accordance with the present invention;

FIG. 3 is illustrated one patterned casing in accordance with the present invention;

FIG. 4 is illustrated another patterned casing in accordance with the present invention;

FIG. 5 is illustrated yet another patterned casing in accordance with the present invention.

### DETAILED DESCRIPTION OF THE PREFERRED EMBODIMENT

The invention discloses an injection mold with an interchangeable mold core having different patterns to produce different pattern casings of an USB Ethernet external network adapter. The interchangeable mold core may be replaced by another one directly while the injection mold is in the injection-molding machine without removal of the mold. That is, the different pattern casings may be produced by the injection mold in accordance with the present invention via the interchangeable mold core replacement as a manufacture interval.

The interchangeable mold core in accordance with the present invention, having no cooling pipe therein, may have a compact dimension and be replaced in the injection-molding machine easily. Advantageously, the whole surface pattern of the interchangeable mold core may be changed whereby the injection casing may have a lot of textures. Moreover, the weight of the mold core is light because of the compact dimension. Thus, the mold core is replaced easily in the injection-molding machine without need of any heavy tools, for example, a hanging bracket or an overhead crane.

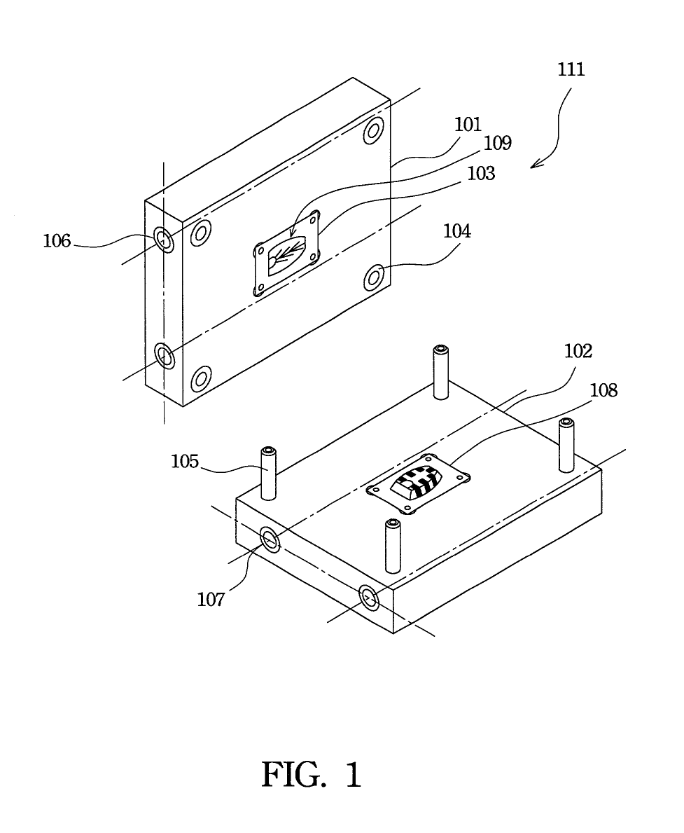

FIG. 1 shows a perspective view of an injection mold in accordance with the present invention. The injection mold 111 in accordance with the present invention includes a mold cavity 101 coupled with a female mold core 103 forming the surface texture of an injection product. A mold plunger 102 coupled with a male mold core 108 forming the interior structure of the injection product. The mold cavity 101 and the mold plunger 102 are connected with guide holes 104 and guide pins 105. The female mold core 103 and the male mold core 108 are posited face to face in the injection mold 111. The surfaces of the female mold cores 103 are produced with multiple forming patterns 109. While the injection mold 111 closed, the female mold core 103 and the male mold core 108 are closed, an injection hole (not shown) of casings are formed and the different texture casings are produced therein. The injection mold 111 in accordance with the present invention may produce different texture casings by changing the female mold core 103. The different forming patterns 109 comprise a concave pattern, a convex pattern, a flat pattern or a combination thereof. Correspondingly, the textures of the casing comprise a concave texture, a convex texture, a flat texture or a combination thereof. As depicted in the drawing, the cooling pipes 106 and 107 go through the mold cavity 101 and the mold plunger 102 respectively, but without through the female mold core 103 and the male mold core 108. Thus, the dimension of the female mold core 103 and the male mold core 108 may be more compact and will be easy to replacement.

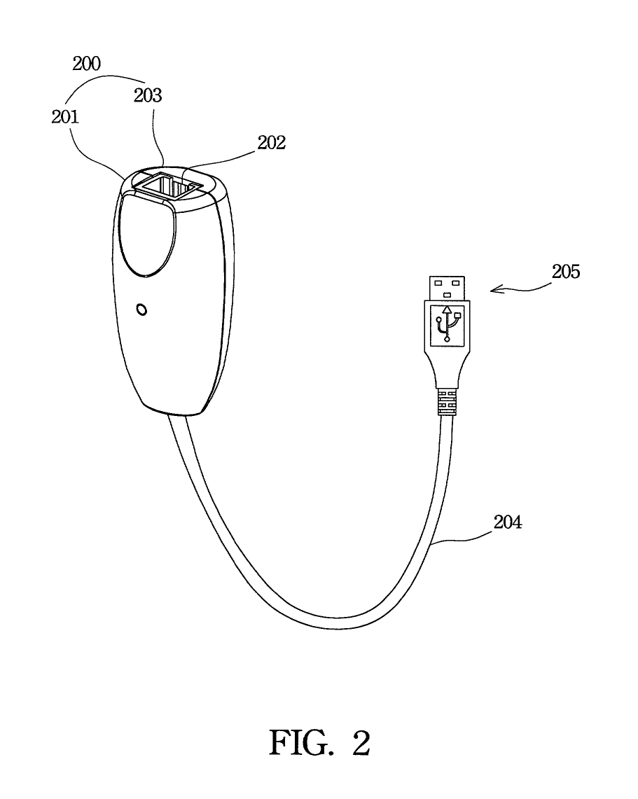

Referring to FIG. 2, it is illustrated a final product of a mini USB Ethernet external network adapter, wherein the casing 200 in the Ethernet end comprises an upper cover 201 and a lower cover 203. The other components include a RJ-45 connector 202, a cable 204 and an USB connector 205.

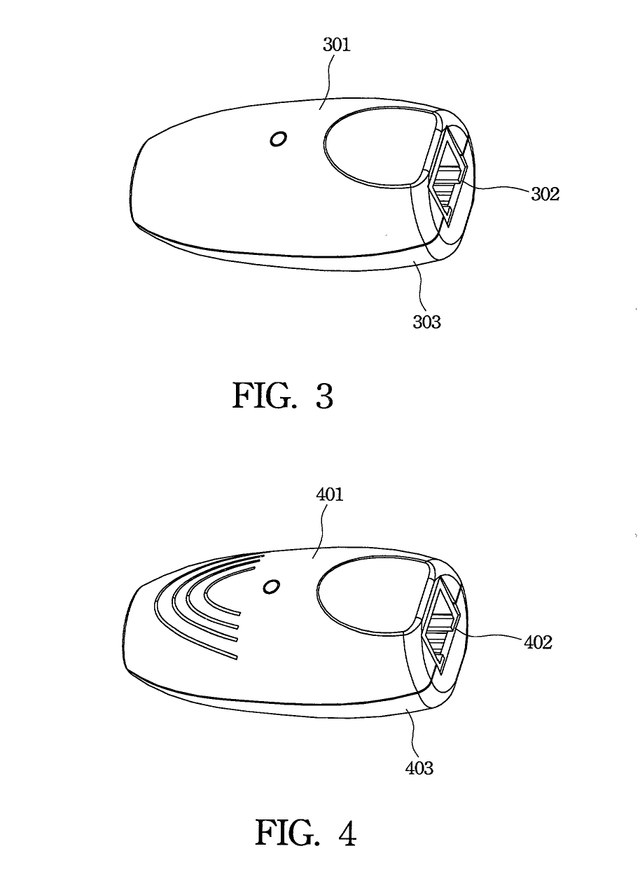

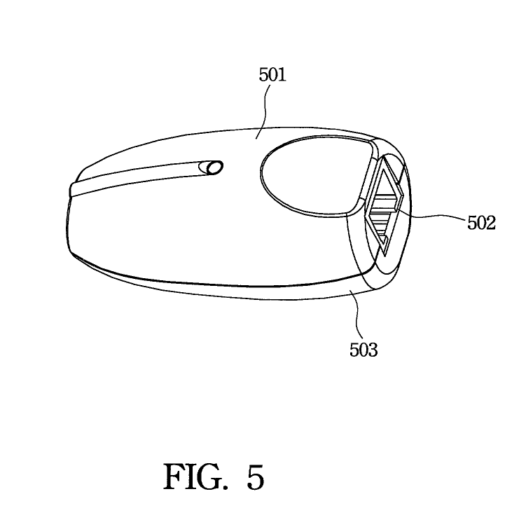

Referring to FIGS. 3-5, there is a set of various texture casings produced by the mold in accordance with the present invention. As shown in FIGS. 3-5, the textures of upper covers 301, 401 and 501 are different, but the interior structures are the same. In the same manner, it may apply to the lower covers 303, 403 and 503. Thus, There are more choices of combination. For example, the upper cover 301 may couple with the lower covers 303, 403 or 503. The lower cover 303 may couple with the upper covers 301, 401 or 501. Additionally, the color of the upper covers 301, 401 and 501 may be changed in different injection works. Similarly, the color of the lower covers 303, 403 and 503 may be changed in different injection works. Accordingly, the product in accordance with the present invention may have more choices of combination. Finally, the RJ-45 connectors 302, 402 and 502 are a standard connector of Ethernet, thereby may be connected with most Ethernet.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. An injection mold structure having multiple mold cores for an injection casing of an external network adapter, said injection casing including an upper cover and a lower cover coupled together, comprising:
a mold plunger;
a mold cavity to seal with said mold plunger; and
a female mold core and a male mold core, mounted on said mold cavity and said mold plunger respectively, and closed face to face to form an injection hole for injecting said upper cover or lower cover, said female mold core having a plurality of patterns for forming a plurality of textures of said upper cover or lower cover, said textures of said upper cover or lower cover changed by replacing said female mold core with different textures.

2. The mold structure according to claim 1, wherein said textures comprise a concave texture, a convex texture, a flat texture or a combination thereof.

3. The mold structure according to claim 1, wherein said female mold core and said male mold core have no cooling pipes.

4. The mold structure according to claim 1, wherein said female mold core is replaced on said mold cavity directly.
